(19) United States
(12) Patent Application Publication
(10) Pub. No.: US 2025/0138356 A1
(43) Pub. Date: May 1, 2025

(54) Display Device and Display Panel

(71) Applicant: LG Display Co., Ltd., Seoul (KR)

(72) Inventors: Gyu-Sik Won, Paju-si (KR); ChulWoo Park, Paju-si (KR); DaeHyun Nam, Paju-si (KR); Chansoo Park, Paju-si (KR); Hyunje Bang, Paju-si (KR)

(21) Appl. No.: 18/827,010

(22) Filed: Sep. 6, 2024

(30) Foreign Application Priority Data
Oct. 25, 2023 (KR) 10-2023-0144047

(51) Int. Cl. G02F 1/1333; G02F 1/1335; G02F 1/13363

(52) U.S. Cl. CPC G02F 1/13338; G02F 1/133512; G02F 1/133514; G02F 1/13363

(57) ABSTRACT

A display panel comprises an optical area included in a display area displaying an image and transmitting light, and a normal area included in the display area and located outside the optical area. A liquid crystal layer may be in the optical area and the normal area, and the display panel may include a first color filter on one side of a substrate in the optical area and the normal area, a compensation layer on one side of the substrate and in the optical area, and a second color filter on the compensation layer in the optical area. In this case, it is configured that a height of the first color filter is greater than a height of the second color filter, thereby enabling normal display operation in an optical area overlaping an optical electronic device.

### CROSS-REFERENCE TO RELATED APPLICATION

This application claims the priority from Republic of Korea Patent Application No. 10-2023-0144047, filed on Oct. 25, 2023, which is hereby incorporated by reference in its entirety.

### BACKGROUND

### Field

Embodiments of the present disclosure relate to a display device and a display panel.

### Description of Related Art

As technology advances, a display device may provide shooting functions and various sensing functions in addition to image display functions. Accordingly, a display device is required to equip with electronic devices such as a camera and a detection sensor (which may also be referred to as a light receiving device or sensor).

Since an electronic device may receive light from the front of a display device, the electronic device is required to be installed in a location where light reception is advantageous. Therefore, a camera (i.e., a camera lens) and a detection sensor have to be installed to be exposed to the front of a display device. As a result, a bezel of the display device may become larger or a camera or detection sensor may be installed in a notch or physical hole formed in a display area of the display panel.

Accordingly, as a display device is equipped with electronic devices such as cameras and detection sensors which receive light from the front and perform a specific function, the bezel on the front of the display device may become larger or restrictions may occur in the front design of the display device.

In addition, in the case that a display device includes an electronic device, there may be occurred unexpected image quality deterioration depending on a structure for providing the electronic device.

### SUMMARY

Embodiments of the present disclosure may provide a display panel and a display device having a light transmission structure which allows an electronic device to normally receive light (e.g. visible light, infrared light, or ultraviolet light, etc.) without exposing the electronic device receiving light to the front.

Embodiments of the present disclosure may provide a display panel and a display device capable of normal display driving in an optical area included in a display area of a display panel and overlapping an optical electronic device.

Embodiments of the present disclosure may provide a display panel and a display device capable of reducing the non-display area of a display panel while not exposing an optical electronic device on the front of the display device by providing the optical electronic device such as cameras and detection sensors below a display area of a display panel.

Embodiments of the present disclosure may provide a display device including an optical area in a display area, the display area displaying an image and transmitting light, and a normal area in the display area, the normal area located outside the optical area, wherein the optical area and the normal area include a first substrate, a second substrate on the first substrate, a liquid crystal layer between the first substrate and the second substrate, a first color filter on one side of the second substrate and in the normal area, and a second color filter in the optical area, wherein a height of the first color filter is greater than a height of the second color filter.

According to the embodiments of the present disclosure, there may be provided a display panel and a display device having a light transmission structure which allows an electronic device to normally receive light (e.g. visible light, infrared light, or ultraviolet light, etc.) without exposing the electronic device receiving light to the front.

According to the embodiments of the present disclosure, there may be provided a display panel and a display device without resolution difference between optical and normal areas.

According to the embodiments of the present disclosure, there may be provided a display panel and a display device capable of normal display driving in an optical area included in a display area of a display panel and overlapping an optical electronic device.

According to the embodiments of the present disclosure, there may be provided a display panel and a display device capable of reducing the non-display area of a display panel while not exposing an optical electronic device on the front of the display device by providing the optical electronic device such as cameras and detection sensors below a display area of a display panel.

### BRIEF DESCRIPTION OF THE DRAWINGS

FIGS. 1A, 1B and 1C illustrate display devices according to embodiments of the present disclosure.

FIG. 2 illustrates a system configuration diagram of a display device according to embodiments of the present disclosure.

FIG. 3 illustrates a portion of a display area of a display device according to embodiments of the present disclosure.

FIG. 4 is an enlarged view of area X in FIG. 3 according to embodiments of the present disclosure.

FIG. 5 is a cross-sectional view schematically illustrating a structure of a color filter substrate in a normal area and a first optical area of FIG. 3 according to embodiments of the present disclosure.

FIG. 6 illustrates a portion of a normal area and a first optical area in a display area of a display device according to embodiments of the present disclosure.

FIG. 7 is an enlarged view of area Y of FIG. 6 according to embodiments of the present disclosure.

FIG. 8 is a cross-sectional view schematically showing the structure of the color filter substrate in the normal area and the first optical area of FIG. 6 according to embodiments of the present disclosure.

FIG. 9 schematically illustrates the overall structure of a display device according to embodiments of the present disclosure.

FIGS. 10 and 11 are cross-sectional views taken along line A-B of FIG. 1A according to embodiments of the present disclosure.

### DETAILED DESCRIPTION

Hereinafter, embodiments of the present disclosure are described in detail with reference to the accompanying drawings. In assigning reference numerals to components of each drawing, the same components may be assigned the same numerals even when they are shown on different drawings. When determined to make the subject matter of the disclosure unclear, the detailed of the known art or functions may be skipped. As used herein, when a component “includes,” “has,” or “comprises” another component, the component may add other components unless the component “only” includes, has, or comprises the another component. As used herein, the singular forms “a”, “an” and “the” are intended to include the plural forms as well, unless the context clearly indicates otherwise.

Such denotations as “first,” “second,” “A,” “B,” “(a),” and “(b),” may be used in describing the components of the disclosure. These denotations are provided merely to distinguish a component from another, and the essence, order, or number of the components are not limited by the denotations.

In describing the positional relationship between components, when two or more components are described as “connected”, “coupled” or “linked”, the two or more components may be directly “connected”, “coupled” or “linked” “, or another component may intervene. Here, the other component may be included in one or more of the two or more components that are “connected”, “coupled” or “linked” to each other.

When such terms as, e.g., “after”, “next to”, “after”, and “before”, are used to describe the temporal flow relationship related to components, operation methods, and fabricating methods, it may include a non-continuous relationship unless the term “immediately” or “directly” is used.

When a component is designated with a value or its corresponding information (e.g., level), the value or the corresponding information may be interpreted as including a tolerance that may arise due to various factors (e.g., process factors, internal or external impacts, or noise).

Hereinafter, various embodiments of the present disclosure are described in detail with reference to the accompanying drawings.

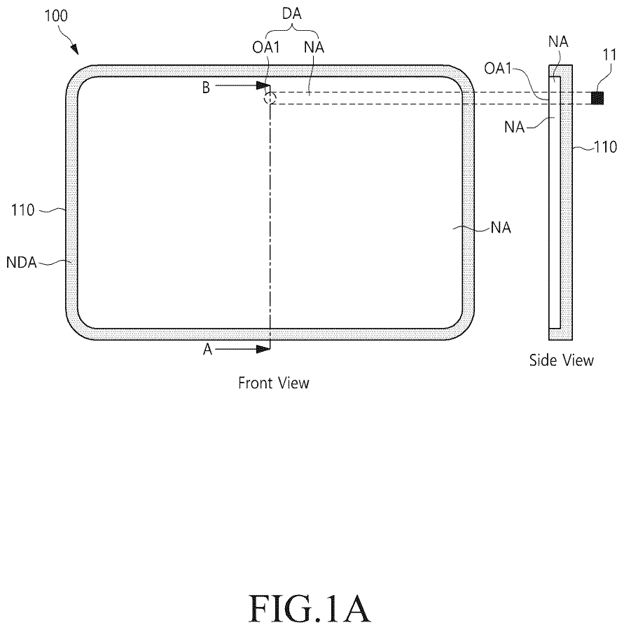

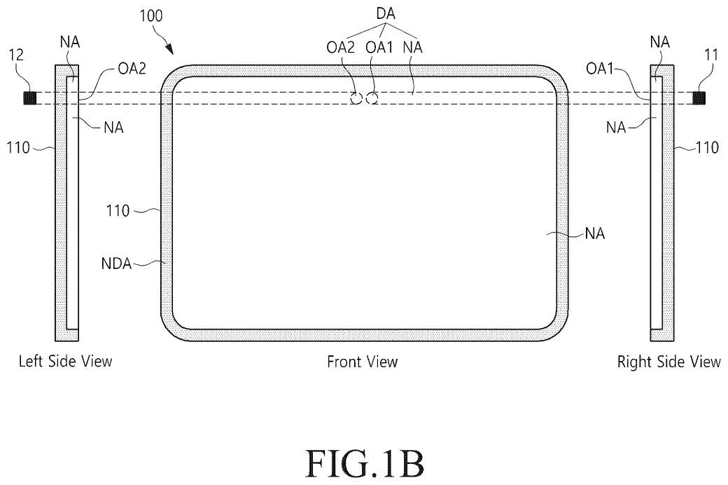

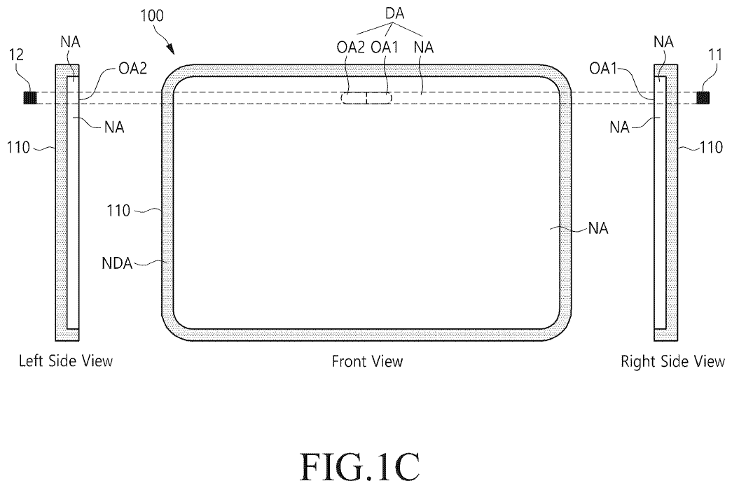

FIGS. 1A, 1B and 1C illustrate a display device 100 according to embodiments of the present disclosure.

Referring to FIGS. 1A, 1B and 1C, a display device 100 according to embodiments of the present disclosure may include a display panel 110 for displaying an image and one or more electronic devices 11 and 12.

The display panel 110 may include a display area DA where an image is displayed and a non-display area NDA where an image is not displayed.

There may be disposed a plurality of subpixels and a plurality of signal lines for driving the plurality of subpixels in the display area DA.

The non-display area NDA may be an area outside the display area DA. Various signal lines may be disposed in the non-display area NDA, and various driving circuits may be connected thereto. The non-display area NDA may be bent so that it is not visible from the front or may be obscured by a case (not shown). The non-display area NDA may be also referred as a bezel or a bezel area.

Referring to FIGS. 1A, 1B and 1C, in a display device 100 according to embodiments of the present disclosure, one or more electronic devices 11 and 12 may be provided and installed separately from the display panel 110, and may be an electronic component located at the lower part of the display panel 110 (i.e., opposite the viewing surface).

The light may enter the front (i.e., viewing side) of the display panel 110, pass through the display panel 110, and may be delivered to one or more electronic devices 11 and 12 located below the display panel 110 (i.e., opposite the viewing surface). For example, light passing through the display panel 110 may include visible light, infrared light or ultraviolet light.

One or more electronic devices 11 and 12 may be devices which receive light passing through the display panel 110 and perform a predetermined operation using the received light. For example, the one or more electronic devices 11 and 12 may include one or more of a photographing device such as a camera (i.e., image sensor), a detection sensor such as a proximity sensor, and an illuminance sensor. Here, for example, the detection sensor may be an infrared sensor.

Referring to FIGS. 1A, 1B and 1C, in a display panel 110 according to embodiments of the present disclosure, the display area DA may include a normal area NA and one or more optical areas OA1 and OA2. One or more optical areas OA1 and OA2 may be areas which overlap with one or more electronic devices 11 and 12.

According to the example of FIG. 1A, the display area DA may include a normal area NA and a first optical area OA1. Here, at least a portion of the first optical area OA1 may overlap with the first electronic device 11.

According to the example of FIG. 1B, the display area DA may include a normal area NA, a first optical area OA1, and a second optical area OA2. In the example of FIG. 1B, the normal area NA may exist between the first optical area OA1 and the second optical area OA2. Here, at least a portion of the first optical area OA1 may overlap with the first electronic device 11, and at least a portion of the second optical area OA2 may overlap with the second electronic device 12.

According to the example of FIG. 1C, the display area DA may include a normal area NA, a first optical area OA1, and a second optical area OA2. In the example of FIG. 1C, there is no normal area NA between the first optical area OA1 and the second optical area OA2. That is, the first optical area OA1 and the second optical area OA2 may be in contact with each other. Here, at least a portion of the first optical area OA1 may overlap with the first electronic device 11, and at least a portion of the second optical area OA2 may overlap with the second electronic device 12.

One or more optical areas OA1 and OA2 are required to include both an image display structure and a light transmission structure. That is, since one or more optical areas OA1 and OA2 are part of the display area DA, emission areas of subpixels for image display are required to be disposed in the one or more optical areas OA1 and OA2. Additionally, a light transmission structure is required to be formed in one or more optical areas OA1 and OA2 to transmit light to one or more electronic devices 11 and 12.

One or more electronic devices 11 and 12 are devices requiring optical reception, and may be located behind (i.e., below or opposite to the viewing surface) the display panel 110 and receive light passing through the display panel 110. One or more electronic devices 11 and 12 may be not exposed to the front (i.e., viewing side) of the display panel 110. Accordingly, when the user looks at the front of the display device 110, the electronic devices 11 and 12 may be not visible to the user.

For example, a first electronic device 11 may be a camera, and a second electronic device 12 may be a detection sensor such as a proximity sensor or illuminance sensor. For example, the detection sensor may be an infrared sensor for detecting infrared rays. Alternatively, the first electronic device 11 may be a detection sensor, and the second electronic device 12 may be a camera.

Hereinafter, for convenience of explanation, there is exemplified a case in which the first electronic device 11 is a camera and the second electronic device 12 is an infrared-based detection sensor. Here, the camera may be a camera lens or an image sensor.

In the case that the first electronic device 11 is a camera, the camera may be located behind (i.e., below) the display panel 110, but may be a front camera for photographing the front direction of the display panel 110. Accordingly, the user may view a viewing surface of the display panel 110 and take pictures or self-photographs using a camera which is not visible to the viewing surface.

The normal area NA and one or more optical areas OA1 and OA2 may be areas capable of dislaying an image. However, the normal area NA may be an area in which a light transmission structure does not need to be formed, and one or more optical areas OA1 and OA2 may be areas in which a light transmission structure is required to be formed.

Therefore, one or more optical areas OA1 and OA2 are required to have transmittance above a specific level, and the normal area NA may not have light transmittance or may have low transmittance below a specific level.

For example, one or more optical areas OA1 and OA2 and the normal area NA may have different resolutions, subpixel arrangement structures, number of subpixels per unit area, electrode structures, line structures, electrode arrangement structures, or line arrangement structures etc.

For example, the number of subpixels per unit area in one or more optical areas OA1 and OA2 may be smaller than the number of subpixels per unit area in the normal area NA. That is, the resolution of one or more optical areas OA1 and OA2 may be lower than the resolution of the normal area NA. Here, the number of subpixels per unit area may mean the same as resolution, pixel density, or pixel integration. For example, a unit of the number of subpixels per unit area may be PPI (Pixels Per Inch), which means the number of pixels in 1 inch.

For example, the number of subpixels per unit area in the first optical area OA1 may be less than the number of subpixels per unit area in the normal area NA. The number of subpixels per unit area in the second optical area OA2 may be greater than or equal to the number of subpixels per unit area in the first optical area OA1, and may be less than the number of subpixels per unit area in the normal area NA.

Meanwhile, as a method to increase the transmittance of at least one of the first optical area OA1 and the second optical area OA2, there may be applied a differential pixel density design method, as described above. According to the differential pixel density design method, the display panel 110 may be designed so as for the number of subpixels per unit area of at least one of the first optical area OA1 and the second optical area OA2 to be less than the number of subpixels per unit area of the normal area NA.

However, in some cases, a differential pixel size design method may be applied as another method to increase the transmittance of at least one of the first optical area OA1 and the second optical area OA2. According to the differential pixel size design method, the display panel 110 may be designed so as for the number of subpixels per unit area of at least one of the first optical area OA1 and the second optical area OA2 to be the same as or similar to the number of subpixels per unit area of the normal area NA, but so as for a size of each subpixel SP (i.e., the size of the emission area) disposed in at least one of the first optical area OA1 and the second optical area OA2 to be smaller than the size of each subpixel SP (i.e., the size of the emission area) placed in the normal area NA.

Hereinafter, for convenience of explanation, it will be exemplified a case in which a differential pixel density design method is applied among the two methods (i.e., a differential pixel density design method and a differential pixel size design method) to increase the transmittance of at least one of the first optical area OA1 and the second optical area OA2. Accordingly, hereinafter, a small number of subpixels per unit area may correspond to a small subpixel size, and a large number of subpixels per unit area may correspond to a large subpixel size.

The first optical area OA1 may have various shapes such as circular, oval, square, hexagon, or octagon. The second optical area OA2 may have various shapes, such as circular, oval, square, hexagon, or octagon. The first optical area OA1 and the second optical area OA2 may have the same shape or different shapes.

Referring to FIG. 1C, in the case that the first optical area OA1 and the second optical area OA2 are in contact, the entire optical area including the first optical area OA1 and the second optical area OA2 may also have various shapes, such as circular, oval, square, hexagon, or octagon. Hereinafter, for convenience of explanation, it will be exemplified a case in which each of the first optical area OA1 and the second optical area OA2 has a circular shape.

In the display device 100 according to the embodiments of the present disclosure, if the first electronic device 11, which is not exposed to the outside and is hidden at the bottom of the display panel 100, is a camera, a display device 100 according to embodiments of the present disclosure may be referred as a display device to which UDC (under display camera) technology is applied.

Accordingly, in the display device 100 according to embodiments of the present disclosure, there may not be required to be formed a notch or camera hole for camera exposure in the display panel 110, so that there is no reduction in area of the display area DA. Accordingly, the size of the bezel area may be reduced, design restrictions may be eliminated, and the degree of freedom in design may be increased.

In the display device 100 according to embodiments of the present disclosure, although the one or more electronic devices 11 and 12 are hidden behind the display panel 110, the one or more electronic devices 11 and 12 are required to be able to receive light normally and normally perform a designated function thereof.

In addition, in the display device 100 according to embodiments of the present disclosure, although the one or more electronic devices 11 and 12 are hidden behind the display panel 110 and are located overlapping with the display area DA, there is required that the normal image display function is possible in one or more optical areas OA1 and OA2 overlapping with one or more electronic devices 11 and 12 in the display area DA.

Since the above-mentioned first optical area OA1 is designed as a transmission area, the image display characteristics in the first optical area OA1 may be different from those in the normal area NA.

In addition, when designing the first optical area OA1 to improve image display characteristics, there may be a possibility that the transmittance of the first optical area OA1 may decrease.

Therefore, embodiments of the present disclosure may provide a structure of the first optical area OA1 capable of preventing image quality deviation between the first optical area OA1 and the normal area NA and improving the transmittance in the first optical area OA1.

In addition, embodiments of the present disclosure may provide, for the second optical area OA2 in addition to the first optical area OA1, a structure of the second optical area OA2 capable of improving the image quality in the second optical area OA2 and improving the transmittance in the second optical area OA2.

In addition, in the display device 100 according to embodiments of the present disclosure, the first optical area OA1 and the second optical area OA2 are similar in that they are light transmissive areas, but their usage examples may be different. Accordingly, in the display device 100 according to embodiments of the present disclosure, the structure of the first optical area OA1 and the structure of the second optical area OA2 may be designed differently.

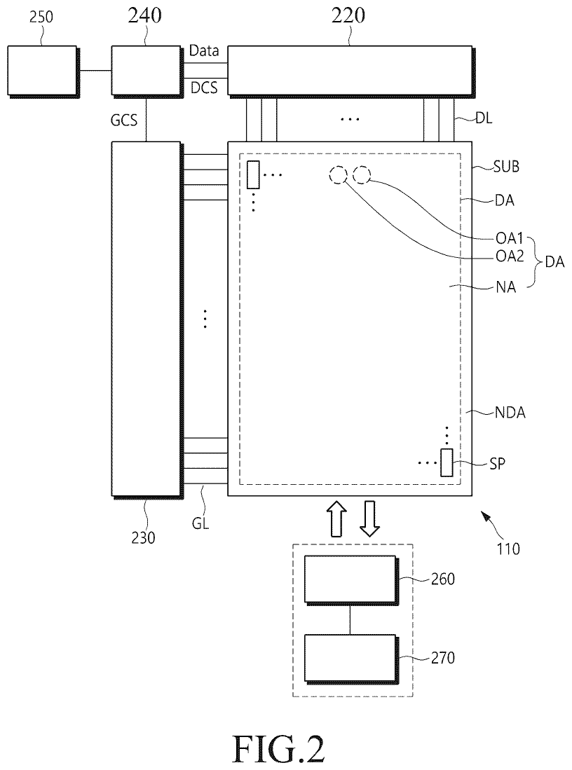

FIG. 2 illustrates a system configuration diagram of a display device 100 according to embodiments of the present disclosure.

Referring to FIG. 2, the display device 100 may include a display panel 110 and a display driving circuit as components for displaying an image.

The display driving circuit may be a circuit for driving the display panel 110, and may include a data driving circuit 220, a gate driving circuit 230 and a display controller 240.

The display panel 110 may include a display area DA for displaying an image and a non-display area NDA where an image is not displayed. The non-display area NDA may be an area outside the display area DA, and may also be referred to as a bezel area. All or part of the non-display area NDA may be an area visible from the front of the display device 100, or may be an area which is bent and not visible from the front of the display device 100.

The display panel 110 may include a substrate SUB and a plurality of subpixels SP disposed on the substrate SUB. Additionally, the display panel 110 may further include various types of signal lines to drive the plurality of subpixels SP.

The display device 100 according to embodiments of the present disclosure may be a liquid crystal display device.

Various types of signal lines include in the display device 100 may include a plurality of data lines DL transmitting data signals (also referred to as data voltages or image signals) and a plurality of gate lines GL transmitting gate signals (also referred to as scan signals).

The plurality of data lines DL and the plurality of gate lines GL may cross each other. Each of the plurality of data lines DL may be arranged to extend in a first direction. Each of the plurality of gate lines GL may be arranged to extend in a second direction. Here, the first direction may be a column direction and the second direction may be a row direction. Alternatively, the first direction may be a row direction and the second direction may be a column direction.

The data driving circuit 220 is a circuit for driving a plurality of data lines DL, and may output data signals to the plurality of data lines DL. The gate driving circuit 230 is a circuit for driving a plurality of gate lines GL, and may output gate signals to the plurality of gate lines GL.

The display controller 240 may be a device for controlling the data driving circuit 220 and the gate driving circuit 230, and may control the driving timing for the plurality of data lines DL and the driving timing of the plurality of gate lines GL.

The display controller 240 may supply a data driving control signal DCS to the data driving circuit 220 to control the data driving circuit 220, and may supply a gate driving control signal GCS to the gate driving circuit 230 to control the gate driving circuit 230.

The display controller 240 may receive input image data from a host system 250 and supply image data to the data driving circuit 220 based on the input image data.

The data driving circuit 220 may receive image data in digital form from the display controller 240 and convert the received image data into analog data signals to output to a plurality of data ines DL.

The gate driving circuit 230 may receive a first gate voltage corresponding to the turn-on level voltage and a second gate voltage corresponding to the turn-off level voltage along with various gate driving control signals GCS, and may generate gate signals and supply the generated gate signals to the plurality of gate lines GL.

For example, the data driving circuit 220 may be connected to the display panel 110 using a tape automated bonding (TAB) method, or may be connected to the bonding pad of the display panel 110 using a chip-on-glass (COG) or chip-on-panel (COP) method, or may be implemented using a chip-on-film (COF) method and connected to the display panel 110.

The gate driving circuit 230 may be connected to the display panel 110 using a tape automated bonding (TAB) method, or may be connected to the bonding pad of the display panel 110 using a chip-on-glass (COG) or chip-on-panel (COP) method, or may be implemented using a chip-on-film (COF) method and connected to the display panel 110. Alternatively, the gate driving circuit 230 may be a gate-in-panel (GIP) type and may be formed in the non-display area NDA of the display panel 110. The gate driving circuit 230 may be disposed on or connected to the substrate. That is, if the gate driving circuit 230 is a GIP type, the gate driving circuit 230 may be disposed in the non-display area NDA of the substrate. The gate driving circuit 230 may be connected to the substrate if the gate driving circuit 230 is a chip-on-glass (COG) type, a chip-on-film (COF) type, etc.

Meanwhile, at least one of the data driving circuit 220 and the gate driving circuit 230 may be disposed in the display area DA of the display panel 110. For example, at least one of the data driving circuit 220 and the gate driving circuit 230 may be arranged not to overlap the subpixels SP, or may be arranged to partially or entirely overlap with the subpixels SP.

The data driving circuit 220 may be connected to one side (e.g., the upper or lower side) of the display panel 110. Depending on the driving method, panel design method, etc., the data driving circuit 220 may be connected to both sides (e.g., upper and lower sides) of the display panel 110, or may be connected to two or more of the four sides of the display panel 110.

The gate driving circuit 230 may be connected to one side (e.g., left or right side) of the display panel 110. Depending on the driving method, panel design method, etc., the gate driving circuit 230 may be connected to both sides (e.g., left and right side) of the display panel 110, or may be connected to two or more of the four sides of the display panel 110.

The display controller 240 may be implemented as a separate component from the data driving circuit 220, or may be integrated with the data driving circuit 220 and implemented as an integrated circuit.

The display controller 240 may be a timing controller used in typical display technology, or may be a control device capable of further performing other control functions including a timing controller, or may be a control device different from the timing controller, or may be a control device other than a timing controller, or may be a circuit within the control device. The display controller 240 may be implemented with various circuits or electronic components, such as an integrated circuit (IC), a field programmable gate array (FPGA), an application specific integrated circuit (ASIC), or Processor.

The display controller 240 may be mounted on a printed circuit board, a flexible printed circuit, etc., and may be electrically connected to the data driving circuit 220 and the gate driving circuit 230 through a printed circuit board, a flexible printed circuit.

The display controller 240 may transmit and receive signals with the data driving circuit 220 according to one or more predetermined interfaces. For example, the interface may include a low voltage differential signaling (LVDS) interface, an embedded clock point-point interface (EPI) interface, or a serial peripheral interface (SPI).

In order to provide not only an image display function but also a touch sensing function, the display device 100 according to embodiments of the present disclosure may include a touch sensor and a touch sensing circuit for detecting an occurrenace of a touch by a touch object such as a finger or pen or for detecting a touch position by sensing the touch sensor.

The touch sensing circuit may include a touch driving circuit 260 for driving and sensing a touch sensor to generate and output touch sensing data, and a touch controller 270 for detecting the occurrence of a touch or detecting the touch position using touch sensing data.

The touch sensor may include a plurality of touch electrodes. The touch sensor may further include a plurality of touch lines to electrically connect a plurality of touch electrodes and the touch driving circuit 260.

The touch sensor may exist outside the display panel 110 in the form of a touch panel or may exist inside the display panel 110. If the touch sensor exists outside the display panel 110 in the form of a touch panel, the touch sensor may be referred to as an external type. If the touch sensor is an external type, the touch panel and the display panel 110 may be manufactured separately and combined during the assembly process. The external touch panel may include a touch panel substrate and a plurality of touch electrodes on the touch panel substrate.

If the touch sensor exists inside the display panel 110, the touch sensor may be formed on the substrate SUB along with signal lines and electrodes related to display driving during the manufacturing process of the display panel 110.

The touch driving circuit 260 may supply a touch driving signal to at least one of the plurality of touch electrodes and generate touch sensing data by sensing at least one of the plurality of touch electrodes.

The touch sensing circuit may perform touch sensing using a self-capacitance sensing method or a mutual-capacitance sensing method.

The touch driving circuit 260 and the touch controller 270 included in the touch sensing circuit may be implemented as separate devices or as one device. Additionally, the touch driving circuit 260 and the data driving circuit 220 may be implemented as separate devices or as one device.

The display device 100 may further include a power supply circuit which supplies various types of power to the display driving circuit and/or the touch sensing circuit.

The display device 100 according to embodiments of the present disclosure may be a mobile terminal such as a smart phone or tablet, or a monitor or television of various sizes, but is not limited thereto, and may be a display of various types and sizes capable of displaying information or images.

As described above, in the display panel 110, the display area DA may include a normal area NA and one or more optical areas OA1 and OA2. The normal area NA and one or more optical areas OA1 and OA2 may be areas capable of displaying images. However, the normal area NA is an area in which a light transmission structure does not need to be formed, and the one or more optical areas OA1 and OA2 are areas in which a light transmission structure needs to be formed.

As described above, the display area DA in the display panel 110 may include one or more optical areas OA1 and OA2 along with the normal area NA. However, for convenience of explanation, it will be exemplified a case in which the display area DA includes the first optical area OA1.

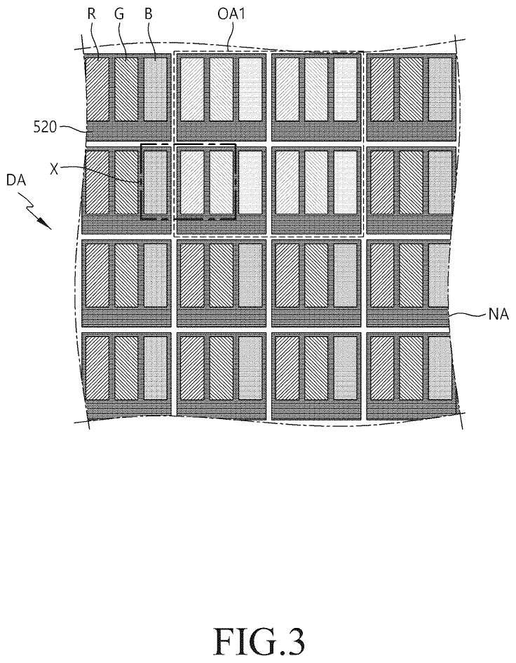

FIG. 3 illustrates a portion of a display area DA of a display device according to embodiments of the present disclosure.

Referring to FIG. 3, a normal area NA and a first optical area OA1 may be disposed in the display area DA of the display device according to embodiments of the present disclosure.

Each of the normal area NA and the first optical area OA1 may include a plurality of subpixels SP. Each of the plurality of subpixels SP included in the normal area NA and the first optical area OA1 may include one light emitting area or one emission area.

The emission area may be an area which emits light of at least one color among red, green, and blue, however, the display device according to embodiments of the present disclosure is not limited thereto.

The remaining area excluding the emission area may be an area overlapping with a black matrix 520.

A red color filter may be disposed in an area that emits red light, a green color filter may be disposed in an area that emits green light, and a blue color filter may be disposed in an area that emits blue light.

Referring to FIG. 3, the sizes of red emission areas in the normal area NA and the first optical area OA1 may be the same, the sizes of green emission areas in the normal area NA and the first optical area OA1 may be the same, and the sizes of blue emission areas of the normal area NA and the first optical area OA1 may be the same. However, embodiments of the present disclosure are not limited thereto, and in some cases, the sizes of the red emission areas in the normal area NA and the first optical area OA1 may be different from each other, or the sizes of the green emission areas of the normal area NA and the first optical area OA1 may be different from each other, or the sizes of the blue emission areas of the normal area NA and the first optical area OA1 may be different from each other.

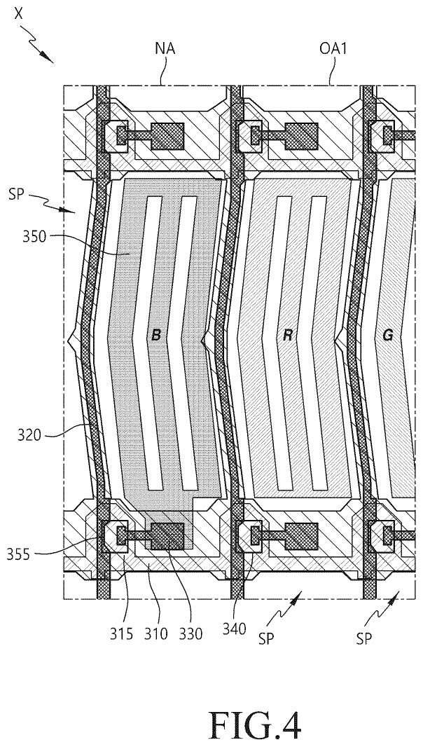

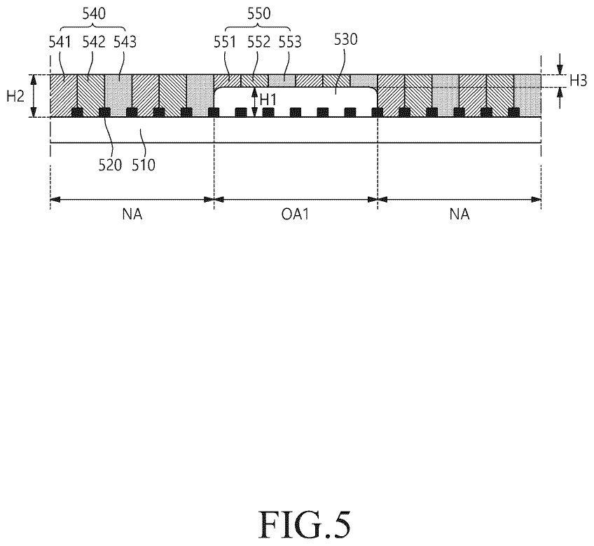

Hereinafter, it will be described a structure of the display device according to embodiments of the present disclosure in detail with reference to FIGS. 4 and 5.

FIG. 4 is an enlarged view of area X in FIG. 3 according to embodiments of the present disclosure. FIG. 5 is a cross-sectional view schematically illustrating a structure of a color filter substrate in the normal area and the first optical area OA1 of FIG. 3 according to embodiments of the present disclosure.

Referring to FIG. 4, a size of each subpixel SP disposed in the normal area NA and the first optical area OA1 may be the same. The subpixel SP may be an area defined by the intersection of the gate line 310 and the data line 320.

Referring to FIG. 4, each subpixel included in the normal area NA and the first optical area OA1 may include a plurality of gate lines 310, a gate electrode 315 protruding from the gate line 310, a data line 320, a source electrode 335 protruding from data line 320, a drain electrode 330 spaced apart from source electrode 335, an active layer 340, and a pixel electrode 350.

The pixel electrode 350 disposed in each subpixel may be electrically connected to the drain electrode 330.

Each subpixel may include a color filter which overlaps at least a portion of the pixel electrode 350. One pixel electrode 350 may overlap with one color filter.

The emission area of the normal area NA and the first optical area OA1 may be an area where the pixel electrodes 350 disposed in each of the plurality of subpixels SP overlap with the color filter, and may be an area where light of a specific color is emitted.

A thickness of a color filter disposed in the normal area NA may be different from a thickness of a color filter disposed in the first optical area OA1. For example, the thickness of the color filter disposed in the normal area NA may be thicker or greater than the thickness of the color filter disposed in the first optical area OA1.

Accordingly, the transmittance of the plurality of subpixels disposed in the first optical area OA1 may be higher than the transmittance of the plurality of subpixels disposed in the normal area NA.

In addition, color coordinates of the light emitted from the first optical area OA1 and color coordinates of the light emitted from the normal area NA may be different. However, the color coordinate characteristics of the display device according to the embodiments of the present disclosure are not limited to this, and the color coordinates of the light emitted from the first optical area OA1 and the color coordinates of the light emitted from the normal area NA may be the same.

Referring to FIG. 5, a black matrix 520, a compensation layer 530, a first color filter 540, and a second color filter 550 may be disposed on a color filter substrate 510. Here, the color filter substrate is also called a color filter array substrate or substrate.

Specifically, referring to FIG. 5, a black matrix 520 including a plurality of openings may be disposed on the color filter substrate 510 in the normal area NA and the first optical area OA1.

Referring to FIG. 5, in the normal area NA, a plurality of first color filters 540 may be disposed on the color filter substrate 510 on which the black matrix 520 is disposed.

The black matrix 520 may be disposed between color filters of different colors.

Referring to FIG. 5, the plurality of first color filters 540 may include a first red color filter 541, a first green color filter 542, and a first blue color filter 543.

In the normal area NA, an area emitting red light may be an area overlapping with the first red color filter 541, and an area emitting green light may be an area overlapping with the first green color filter 542, and an area emitting blue light may be an area overlapping with the first blue color filter 543.

Referring to FIG. 5, in the first optical area OA1, a compensation layer 530 may be disposed on the color filter substrate 510 on which the black matrix 520 is disposed.

The compensation layer 530 may include a transparent organic insulating material. For example, a planarization layer may be disposed on a thin film transistor array substrate on which a gate electrode 315, an active layer 340, a source electrode 335 and a drain electrode 330 are disposed to planarize the surface of the substrate in FIG. 4. In addition, the compensation layer 530 may include the same material as the material of the planarization layer disposed on the gate electrode 315, the active layer 340, the source electrode 335, and the drain electrode 330, but the embodiments of the disclosure are not limited thereto.

There may be sufficient for the compensation layer 530 to be made of an insulating material which does not reduce the transparency of the display panel in the light emission area.

Here, a first height H1 of the compensation layer 530 may be lower than a second height H2 of the first color filter 540 disposed in the normal area NA. Accordingly, at the boundary between the normal area NA and the first optical area OA1, one or more steps may be provided between the first color filter 540 disposed in the normal area NA and the compensation layer 530 disposed in the first optical area OA1.

A plurality of second color filters 550 may be disposed on the compensation layer 530.

The second color filter 550 may include a second red color filter 551, a second green color filter 552, and a second blue color filter 553.

In the first optical area OA1, an area emitting red light may be an area overlapping with the second red color filter 551, and an area emitting green light may be an area overlapping with the second green color filter 552, and an area emitting blue light may be an area overlapping with the second blue color filter 553.

A third height H3 of the second color filter 550 may be lower than the second height H2 of the first color filter 540.

In addition, the sum of the first height H1 of the compensation layer 530 and the third height H3 of the second color filter 550 may be equal to the second heights H2 of the first color filter 540.

Referring to FIG. 5, the structure of the display device according to embodiments of the present disclosure is not limited to this, and the sum of the first height H1 of the compensation layer 530 and the third height H3 of the second color filter 550 is equal to the second heights H2 of the first color filter 540, so that at the boundary between the normal area NA and the first optical area OA1, the first color filter 540 disposed in the normal area NA and the second color filter 550 disposed in the first optical area OA1 may be flat without any step.

However, the structure of the display device according to the embodiments of the present disclosure is not limited to this, and sum of the first height H1 of the compensation layer 530 and the third height H3 of the second color filter 550 may be greater or smaller than the second height H2 of the first color filter 540. In this way, the transmittance of the normal area NA and the first optical area OA1 may be adjusted by adjusting the heights of the compensation layer 530, the first color filter 540, and the second color filter 550.

Here, each of the first height H1 of the compensation layer 530, the second height H2 of the first color filter 540, and the third height H3 of the second color filter 550 may refer to the shortest length in the same direction as the direction in which the black matrix 520 is stacked on the color filter substrate 510.

The first and second color filters 540 and 550 may transmit light of a specific wavelength and absorb light of other wavelengths, and if the thickness thereof is great, there may serve to lower or reduce the transmittance of light generated from the liquid crystal layer.

The compensation layer 530 made of a transparent organic material is disposed in the emission area of the first optical area OA1 where the optical electronic device is disposed, and the second color filter 550 having a thickness thinner than the first color filter 540 is disposed on the compensation layer 530, so that the emission area of each subpixel may emit red, green or blue light while maintaining the transmittance in the first optical area OA1.

That is, it is possible to secure transmittance even without reducing the area of the emission area of the first optical area OA1.

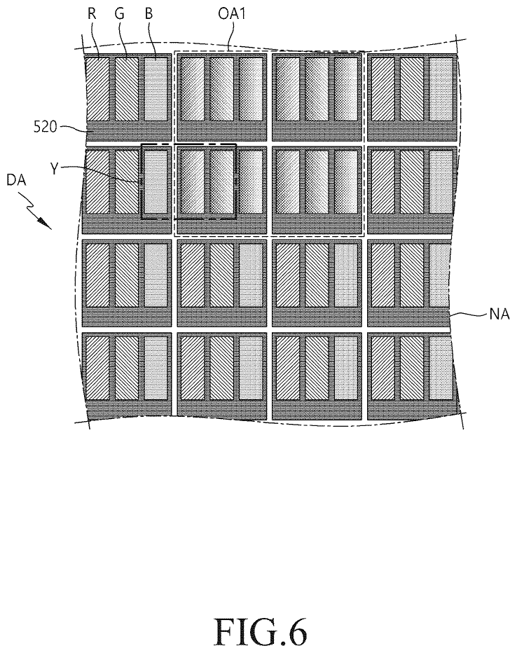

With reference to FIGS. 6 to 8, it will be described the normal area and the first optical area according to embodiments of the present disclosure.

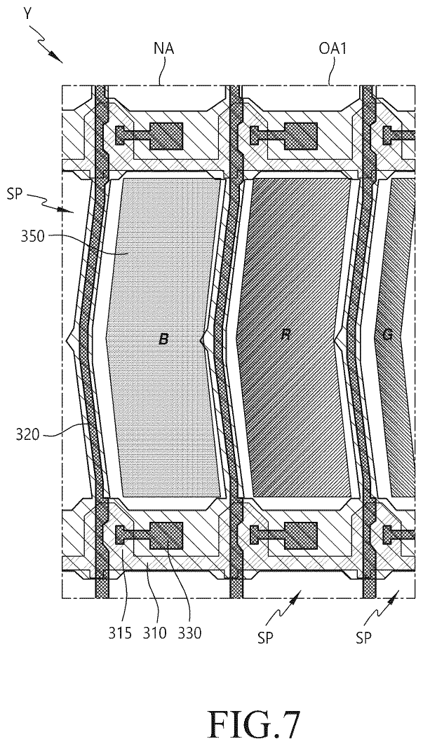

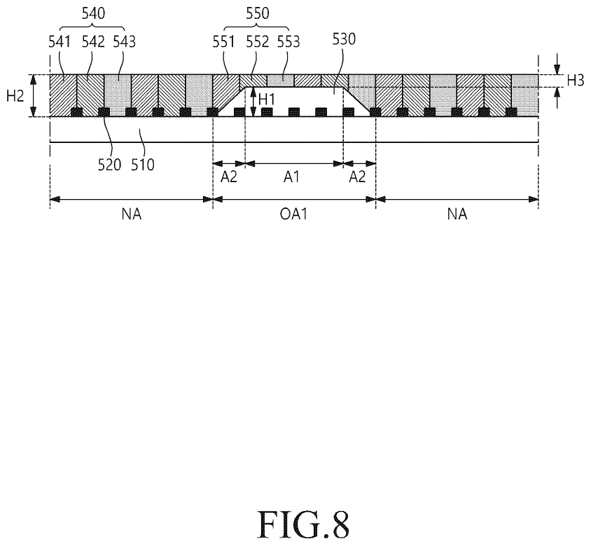

FIG. 6 illustrates a portion of a normal area and a first optical area in a display area of a display device according to embodiments of the present disclosure. FIG. 7 is an enlarged view of area Y of FIG. 6 according to embodiments of the present disclosure. FIG. 8 is a cross-sectional view schematically showing the structure of the color filter substrate in the normal area and the first optical area of FIG. 6 according to embodiments of the present disclosure.

First, referring to FIGS. 6 and 7, a normal area NA and a first optical area OA1 may be disposed in the display area DA of the display device according to embodiments of the present disclosure.

Each of the normal area NA and the first optical area OA1 according to embodiments of the present disclosure may include subpixels SP including an emission area.

Each of the normal area NA and the first optical area OA1 may include a plurality of subpixels SP. Each of the subpixels SP included in the normal area NA and the first optical area OA1 may include one light emission area.

Referring to FIGS. 6 and 7, there may emit light of at least one color of red R, green G, and blue B in areas that overlap with the pixel electrode in each subpixel and do not overlap with the black matrix.

The emission area of the normal area NA and the first optical area OA1 may be an area where the pixel electrodes 350 disposed in each of the plurality of subpixels SP overlap with the color filter, and may be an area that emits light of a specific color.

A thickness of the color filter disposed in the normal area NA may be different from a thickness of the color filter disposed in the first optical area OA1. At the same time, the thickness of at least two color filters among the plurality of color filters disposed in the first optical area OA1 may be different.

Accordingly, the transmittance of the emission areas of the normal area NA and the first optical area OA1 may be different, and the transmittance of at least two emission areas among the emission areas disposed in the first optical area OA1 may be different from each other.

In addition, the color coordinates of the light emitted from the first optical area OA1 may be different from the color coordinates of the light emitted from the normal area NA. In addition, the color coordinates of the light emitted from at least two emission areas among the emission areas disposed in the first optical area OA1 may be different from each other. Here, the two emission areas may refer to as two emission areas emitting red light, two emission areas emitting green light, or two emission areas emitting blue light.

Referring to FIG. 8, a black matrix 520 including a plurality of openings may be disposed on the color filter substrate 510 in the normal area NA and the first optical area OA1.

Referring to FIG. 8, in the normal area NA, a plurality of first color filters 540 may be disposed on the color filter substrate 510 on which the black matrix 520 is disposed.

Each of a first red color filter 541, a first green color filter 542, and a first blue color filter 543 included in the plurality of first color filters 540 may have the same second height H2.

Referring to FIG. 8, in the first optical area OA1, a compensation layer 530 may be disposed on the color filter substrate 510 on which the black matrix 520 is disposed.

Referring to FIG. 8, the compensation layer 530 may include a first part A1 having a first height H1 and a second part A2 surrounding the first part A1 and having a height less than the first height H1 of the first part A1.

The second part A2 of the compensation layer 530 may be disposed between the first part A1 of the compensation layer 530 and the first color filter 540 disposed in the normal area NA.

Referring to FIG. 8, a height of the second part A2 of the compensation layer 530 may decrease or may be smaller as it approaches the normal area NA. In another embodiment, the height of the second part A2 of the compensation layer 530 may increase as it approaches the first part A1 of the compensation layer 530.

A second color filter 550 may be disposed on the compensation layer 530.

The second color filter 550 may include a plurality of second red color filters 551, a plurality of second green color filters 552, and a plurality of second blue color filters 553.

Referring to FIG. 8, the second color filter 550 disposed on the first part A1 of the compensation layer 530 may have a third height H3. The second color filter 550 disposed on the second part A2 of the compensation layer 530 may have a height greater than the third height H3.

A height or a thickness of the second color filter 550 disposed on the second part A2 of the compensation layer 530 may increase as it approaches the normal area NA. On the other hand, the height or the thickness of the second color filter 550 disposed on the second part A2 of the compensation layer 530 may decrease as it approaches the first part A1 of the compensation layer 530.

Accordingly, in the first optical area OA1, the transmittance may decrease as it approaches the normal area NA. In addition, in the first optical area OA1, the color coordinate may be closer to the color coordinate of the normal area NA as it approaches the normal area NA.

As above, the height of the second part A2 of the compensation layer 530 is less than the height of the first part A1, and the height of the second color filter 550 disposed on the second part A2 of the compensation layer 530 is greater than that of the second color filter 550 disposed on the first part A1 of the compensation layer 530, so that the boundary between the normal area NA and the first optical area OA1 may be not visible and may appear natural in ON state of the display device.

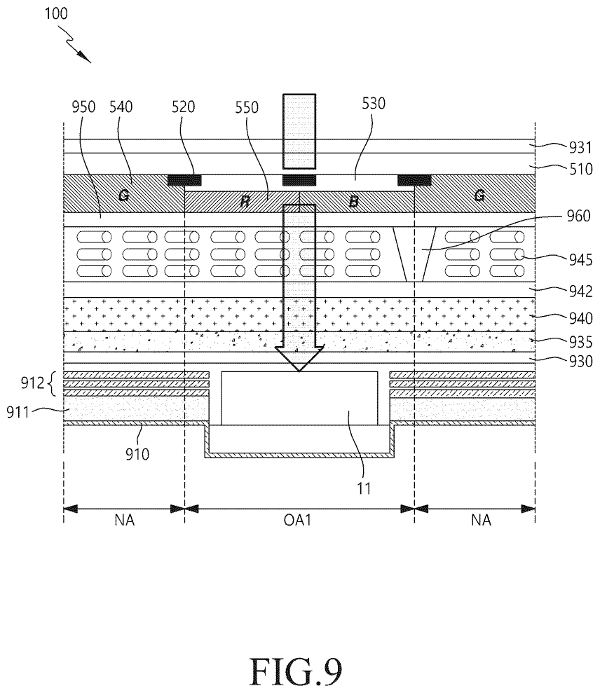

FIG. 9 schematically illustrates the overall structure of a display device according to embodiments of the present disclosure.

Referring to FIG. 9, the display device 100 according to embodiments of the present disclosure may include a backlight unit including a cover bottom 910, a light guide plate 911 and a plurality of optical sheets 912, and a display panel and an optical electronic device 11 disposed on the backlight unit.

Specifically, referring to FIG. 9, the light guide plate 911 may be disposed on the cover bottom 910. A plurality of optical sheets 912 may be disposed on the light guide plate 911.

In addition, the optical electronic device 11 may be disposed in the first optical area OA1 of the display device 100. For example, as shown in FIG. 9, the optical electronic device 11 may be inserted into holes provided in the light guide plate 911 and the plurality of optical sheets 912.

Referring to FIG. 9, there may be disposed a first polarizer 930, a thin film transistor array substrate 935, and a circuit unit 940 including a thin film transistor and a plurality of lines on a plurality of optical sheets 912, and an alignment film 924 may be disposed on the circuit unit 940.

In addition, referring to FIG. 9, a color filter substrate 510 may be disposed to face the thin film transistor array substrate 935.

Referring to FIG. 9, a second polarizer 931 may be disposed on the color filter substrate 510 based on the cross section. Additionally, a black matrix 520, a compensation layer 530, a first color filter 540, and a second color filter 550 may be disposed on the rear of the color filter substrate 510.

In addition, a planarization layer 950 may be disposed on the rear of the first and second color filters 540 and 550. Although not shown in FIG. 9, an additional alignment layer may be disposed on the rear of the planarization layer 950.

Additionally, referring to FIG. 9, a liquid crystal layer 945 may be interposed between the planarization layer 950 and the alignment layer 942.

The liquid crystal layer 945 may be disposed in each of the normal area NA and the first optical area OA1.

In addition, a spacer 960 for maintaining a cell gap may be disposed in a part of the areas where the black matrix 520 is disposed.

Referring to FIG. 9, there may also be designed for the first optical area OA1 where the optical electronic device 11 is disposed to have an emission area.

In addition, the height of the second color filter 550 disposed in the first optical area OA1 is less than the height of the first color filter 540 disposed in the normal area NA, and the compensation layer 530 is disposed on one side of the second color filter 550, so that there may provide an effect of improving the transmittance of the first optical area OA1 and simultaneously realizing the same resolution as that of the normal area NA.

In the case that the area of the emission area is reduced and the area of the transmission area is increased in order to secure the transmittance of the first optical area OA1, the resolution of the first optical area OA1 may inevitably be lowered compared to the normal area NA.

However, the display device according to embodiments of the present disclosure may improve the transmittance of the emission area of the first optical area OA1, so there is not required to secure the transmission area while reducing the area of the emission area. Accordingly, the resolution of the normal area NA and the resolution of the first optical area OA1 may be the same, and accordingly, when the display device 100 is in the ON state, it is possible to prevent a visibility deteriorates due to that the boundary between the first optical area OA1 and the normal area NA is visible.

The backlight unit of the display device 100 may have light sources placed in various locations. Additionally, the position of the optical electronic device 11 is not limited to the position described with reference to FIG. 9.

Hereinafter, it will be described the various positions of the light sources of the backlight unit and the optical electronic device 11.

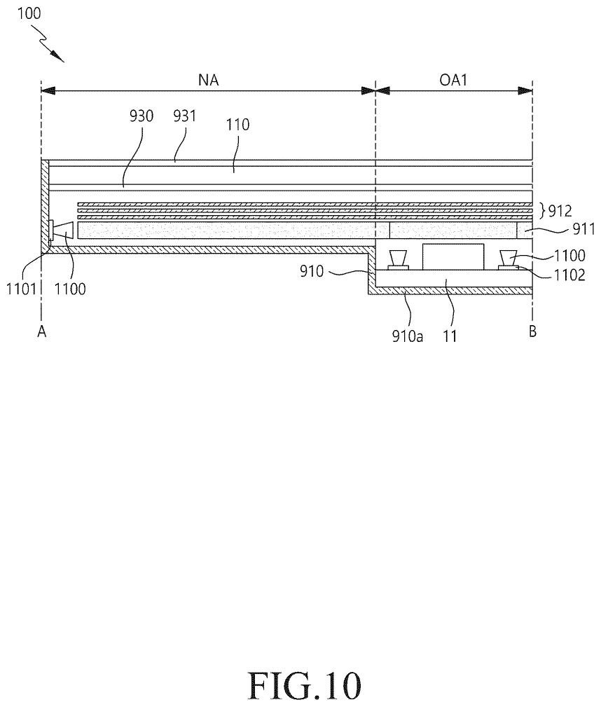

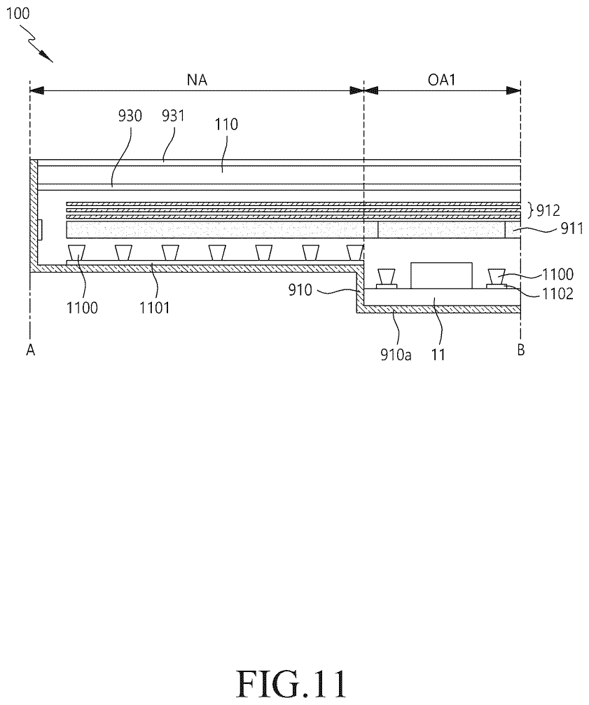

FIGS. 10 and 11 are cross-sectional views taken along line A-B of FIG. 1A according to embodiments of the present disclosure.

First, referring to FIG. 10, the backlight unit of the display device 100 according to embodiments of the present disclosure may include a plurality of light sources 1100.

Some of the plurality of light sources 1100 may be disposed on the side of the light guide plate 911. In addition, although not shown in the drawing, an additional reflector may be disposed on the rear of the light guide plate 911 in the normal area NA.

Referring to FIG. 10, in an area corresponding to the first optical area OA1, a plurality of light sources 1100 may be disposed on the cover bottom 910 and below the light guide plate 911.

In the normal area NA, light may be supplied through the light source 1100 disposed on a first light source circuit board 1101. In addition, in the first optical area OA1, light may be supplied through the light source 1100 disposed on a second light source circuit board 1102.

That is, light may be supplied to the normal area NA and the first optical area OA1 using different light source circuit boards, so that it is possible to minimize or at least reduce the design interference of the normal area NA and the first optical area OA1 in the circuit board.

Referring to FIG. 10, the optical electronic device 11 may be disposed on the rear of the light guide plate 911 in the first optical area OA1. Here, the light guide plate 911 and the plurality of optical sheets 912 may not have holes in the area corresponding to the area where the optical electronic device 11 is disposed.

In the first optical area OA1, a plurality of light sources 1100 and optical electronic devices 11 are required to be disposed within the cover bottom 910, so there may be provided a seating portion 910a of the cover bottom 910.

In the seating portion 910a of the cover bottom 910, a plurality of light sources 1100 may be disposed to surround the optical electronic device 11.

Referring to FIG. 10, the seating portion 910a of the cover bottom 910 may have a shape that protrudes in one direction more than the cover bottom 910 disposed in the normal area NA.

In addition, referring to FIG. 11, a plurality of light sources 1100 may be disposed on the rear of the light guide plate 911.

Specifically, referring to FIG. 11, a plurality of light sources 1100 may be disposed on the back of the light guide plate 911 in an area corresponding to the normal area NA and the first optical area OA1.

Although FIG. 11 illustrates an example of a structure with the uniform spacing between the plurality of light sources 1100, the structure of the display device according to embodiments of the present disclosure is not limited thereto.

For example, the spacing between the light sources 1100 disposed in the normal area NA and the spacing between the light sources 1100 arranged in the first optical area OA1 may be different from each other.

Accordingly, it is possible to adjust the luminance of the normal area NA and the first optical area OA1.

As described above, light may be supplied to the normal area NA and the first optical area OA1 using different light source circuit boards, so that it is possible to adjust the number and position of the light sources 1100 in the normal area NA and the first optical area OA1, and accordingly, to freely adjust the luminance of each area.

According to embodiments of the present disclosure, there may be provided a display panel and a display device without a difference in resolution between the optical area and the normal area.

According to embodiments of the present disclosure, it is possible to provide a display panel and a display device capable of normal display driving in an optical area included in the display area of the display panel and overlapping an optical electronic device.

According to embodiments of the present disclosure, it is possible to provide a display panel and a display device capable of reducing the non-display area of the display panel and not exposing the optical electronic device on the front of the display device by disposing the optical electronic devices such as cameras and detection sensors below the display area of the display panel.

The above description and the accompanying drawings provide an example of the technical idea of the present disclosure for illustrative purposes only. Various modifications, additions and substitutions to the described embodiments will be readily apparent to those skilled in the art without departing from the spirit and scope of the present disclosure. In addition, the disclosed embodiments are intended to illustrate the scope of the technical idea of the present disclosure. Thus, the scope of the present disclosure is not limited to the embodiments shown.

What is claimed is:

1. A display panel, comprising:
a plurality of subpixels for image display, the plurality of subpixels in a normal area and an optical area of the display panel;
a first color filter in the normal area;
a second color filter in the optical area; and
a liquid crystal layer overlapping with the first color filter and the second color filter,
wherein a thickness of the first color filter is greater than a thickness of the second color filter.

2. The display panel of claim 1, wherein a transmittance of the optical area is greater than a transmittance of the normal area.

3. The display panel of claim 1, wherein the normal area surrounds the optical area.

4. The display panel of claim 1, wherein a resolution of the normal area is a same as a resolution of the optical area.

5. The display panel of claim 1, wherein a size of an emission area of each subpixel of a first portion of the plurality of subpixels in the optical area is a same as a size of an emission area of each subpixel of a second portion of the plurality of subpixels in the normal area.

6. The display panel of claim 1, wherein a transmittance of at least a portion of the optical area decreases as the portion of the optical area approaches the normal area.

7. The display panel of claim 1, wherein a thickness of at least a portion of the second color filter in the optical area increases as the portion of the second color filter approaches the normal area.

8. The display panel of claim 1, further comprising:
a compensation layer overlapping the second color filter in the optical area,
wherein the compensation layer comprises a transparent organic material.

9. The display panel of claim 8, wherein the compensation layer has a first thickness, the first color filter in the normal area has a second thickness,
the second color filter in the optical area comprises a pluality color filters, each of the pluality color filters having a third thickness, and
a sum of the first thickness and the third thickness is equal to the second thickness.

10. The display panel of claim 8, wherein the second color filter in the optical area comprises a plurality of color filters, and at least two color filters of the plurality of color filters have different thicknesses.

11. The display panel of claim 10, wherein the compensation layer comprises a first part and a second part that is closer to the normal area than the first part,
wherein a thickness of the first part of the compensation layer is greater than a thickness of the second part of the compensation layer.

12. The display panel of claim 11, wherein a first thickness of a color filter included in the second color filter that overlaps the second part of the compensation layer is greater than a second thickness of a color filter included in the second color filter that overlaps the first part of the compensation layer.

13. The display panel of claim 11, wherein a thickness of the second part of the compensation layer decreases as the second part of the compensation layer approaches the normal area.

14. The display panel of claim 8, further comprising:
a black matrix between subpixels of the plurality of subpixels, the subpixels displaying different colors,
wherein the first color filter, the second color filter, the compensation layer and the black matrix are on a same substrate of the display panel, and
wherein the compensation layer overlaps the black matrix in the optical area, and the compensation layer is between the black matrix and the second color filter.

15. A display device, comprising:
a liquid crystal display panel comprising a first color filter in a normal area of the liquid crystal display panel and a second color filter in an optical area of the liquid crystal display panel; and
an optical electronic device on a rear portion of the liquid crystal display panel in an area corresponding to the optical area of the liquid crystal display panel,
wherein the optical electronic device receives light from a front portion of the liquid crystal display panel, the optical electronic device non-exposed to the front portion of the liquid crystal display panel, and
wherein a thickness of the first color filter is greater than a thickness of the second color filter.

16. The display device of claim 15, further comprising:
a plurality of optical sheets on the rear portion of the liquid crystal display panel; and
a light guide plate on a rear portion of the plurality of optical sheets,
wherein a hole is in the plurality of optical sheets and the light guide plate in an area corresponding to the optical area, and
wherein at least a portion of the optical electronic device is within the hole of the plurality of optical sheets and the light guide plate.

17. The display device of claim 15, further comprising:
a plurality of optical sheets on the rear portion of the liquid crystal display panel;
a light guide plate on a rear portion of the plurality of optical sheets; and
a cover bottom surrounding the plurality of optical sheets and the light guide plate,
wherein the cover bottom includes a seating portion representing an area protruding in one direction in the optical area compared to the normal area, and
wherein the optical electronic device is on the seating portion.

18. The display device of claim 15, further comprising:
a first light source that supplies light to the normal area of the liquid crystal display panel; and
a second light source that supplies light to the optical area of the liquid crystal display panel.

19. The display device of claim 18, wherein the first light source and the second light source are on different circuit boards.

20. The display device of claim 18, wherein the second light source comprises a plurality of light sources that surround the optical electronic device.
